(19) United States
(12) Patent Application Publication
(10) Pub. No.: US 2021/0041859 A1
(43) Pub. Date: Feb. 11, 2021

(54) DATA PROCESSING DEVICE, DATA PROCESSING METHOD AND PROGRAM

(71) Applicant: Mitsubishi Electric Corporation, Tokyo (JP)

(72) Inventor: Osamu NASU, Tokyo (JP)

(73) Assignee: Mitsubishi Electric Corporation, Tokyo (JP)

(21) Appl. No.: 17/045,995

(22) PCT Filed: Apr. 13, 2018
(86) PCT No.: PCT/JP2018/015473

§ 371 Date: Oct. 8, 2020

(51) Int. Cl. G05B 19/418; G06K 9/62

(52) U.S. Cl. CPC G05B 19/41865; G06K 9/6259; G05B 19/4185; G05B 19/4183

(57) ABSTRACT

A data processing device (10) connectable to a machine (20) includes a communicator (130) that communicates with the machine (20), a receiver (140) that receives a setting on a process flow for processing data received by the communicator (130), and a controller (110) that (i) transmits the data received by the communicator (130) to one processor (160) or one of a plurality of processors (160) for performing subprocesses included in the process flow, (ii) causes the one processor (160) or the plurality of processors (160) to perform the subprocesses in an order corresponding to the process flow, and (iii) transmits a processing result obtained from the execution of the subprocesses.

### TECHNICAL FIELD

The present disclosure relates to a data processing device, a data processing method, and a program.

### BACKGROUND ART

At facilities, typically factories, data is collected at the sites and processed for use in production, inspection, and other processes. To meet varying market needs, such data is often processed differently by an existing device for processing data without replacing the device (see, for example, Patent Literature 1).

Patent Literature 1 describes a system including a computer that is connected to machines and incorporates base software and operational software. The base software is preloaded on the computer to pass on data between newly installed operational software and the machines. As a result, the newly installed operational software enables the computer to perform different data processing.

### CITATION LIST

### Patent Literature

Patent Literature 1: Unexamined Japanese Patent Application Publication No. 2017-157189

### SUMMARY OF INVENTION

### Technical Problem

Nowadays, more data is collected at a facility and is processed for various uses, typically through a process flow obtained by combining various processing steps. However, the technique described in Patent Literature 1 uses a single operational software to obtain information from machines, specify a machine to which information is to be output, and output instruction information to the specified machine. Thus, a change in a process flow obtained by combining various processing steps to perform on data involves a complicated task of preparing, each time, a single operational software for realizing the changed process flow.

In response to the above issue, an objective of the present disclosure is easy data processing using a process flow obtained by combining various processing steps.

### Solution to Problem

To achieve the above objective, a data processing device according to the present disclosure is connectable to a machine. The data processing device includes communication means for communicating with the machine, reception means for receiving a setting on a process flow for processing data received by the communication means, and control means for (i) transmitting the data received by the communication means to one processing means or one of a plurality of processing means for performing subprocesses included in the process flow, (ii) causing the one processing means or the plurality of processing means to execute the subprocesses in an order corresponding to the process flow, and (iii) transmitting a processing result obtained from the execution of the subprocesses.

### Advantageous Effects of Invention

The data processing device according to the present disclosure causes one processing means or one of a plurality of processing means for performing subprocesses included in a process flow to execute the subprocesses in the order corresponding to the defined process flow. Various process flows can be executed by changing the order of the execution of the subprocesses. This allows easy data processing using a process flow combining various processing steps.

### BRIEF DESCRIPTION OF DRAWINGS

FIG. 1 is a block diagram of a data processing system according to Embodiment 1 of the present disclosure;

FIG. 2 is a hardware diagram of a data processing device according to Embodiment 1;

FIG. 3 is a diagram showing an example of process flow according to Embodiment 1;

FIG. 4 is a diagram of a functional configuration of the data processing device according to Embodiment 1;

FIG. 5 is a flowchart showing the data processing according to Embodiment 1;

FIG. 6 is a diagram showing an example of management information according to Embodiment 1;

FIG. 7 is a diagram showing a first example of an input screen according to Embodiment 1;

FIG. 8 is a diagram showing a second example of an input screen according to Embodiment 1;

FIG. 9 is an example of a condition table according to Embodiment 1;

FIG. 10 is an example operation table according to Embodiment 1;

FIG. 11A is a diagram showing a first example of intermediate information according to Embodiment 1;

FIG. 11B is a diagram showing a second example of intermediate information according to Embodiment 1;

FIG. 11C is a diagram showing a third example of intermediate information according to Embodiment 1;

FIG. 12 is a diagram showing a fourth example of intermediate information according to Embodiment 1;

FIG. 13 is a diagram showing a fifth example of intermediate information according to Embodiment 1;

FIG. 14 is a diagram of a functional configuration of a data processing device according to Embodiment 2;

FIG. 15 is a diagram showing an example of authentication information according to Embodiment 2;

FIG. 16 is a flowchart showing data processing according to Embodiment 2;

FIG. 17 is a diagram showing a process flow according to a modified example;

FIG. 18 is a first diagram of a functional configuration of a data processing device according to the modified example; and

FIG. 19 is a second diagram of a functional configuration of a data processing device according to another modification.

### DESCRIPTION OF EMBODIMENTS

A data processing system 1000 according to embodiments of the present disclosure is described in detail with reference to the drawings.

### Embodiment 1

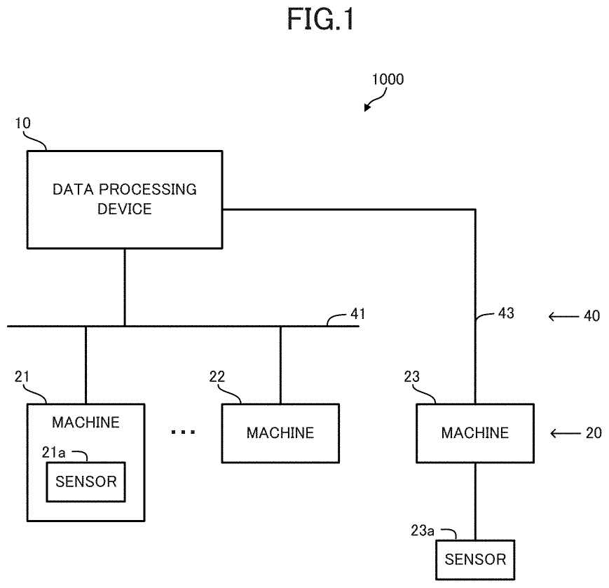

The data processing system 1000 according to the present embodiment processes data transmitted from machines. The data processing system 1000 is installed at a factory as a production manufacturing system. For example, the data processing system 1000 processes data to detect and remove defective products in a manufacturing process, to sort materials, or to check for abnormalities. The data processing system 1000 allows a user to easily design data processing. As shown in FIG. 1, the data processing system 1000 includes machines 21, 22, and 23 that operate in a product manufacturing process and a data processing device 10 that processes data transmitted from the machines 21, 22, and 23.

The data processing device 10 is connected to the machines 21 and 22 through a network 41 and communicates with the machines 21 and 22 by transmitting and receiving signals to and from the machines 21 and 22. The data processing device 10 is also connected to the machine 23 through a network 43 and communicates with the machine 23 by transmitting and receiving signals to and from the machine 23. The networks 41 and 43 are industrial networks that comply with different standards. The networks 41 and 43 may be dedicated lines for serial communication.

The machine 21 includes a sensor 21a used in the product manufacturing process. The sensor 21a is, for example, an optical sensor, a pressure sensor, an ultrasonic sensor, or another detector. The machine 21 periodically transmits data including a sensing result from the sensor 21a to the data processing device 10 at intervals specified by the data processing device 10. The interval is, for example, 10 ms, 100 ms, or 1 sec.

The machine 22 is an actuator or a robot used in the product manufacturing process. The machine 22 operates in accordance with a data processing result obtained by the data processing device 10. In detail, when the machine 22 receives, as a data processing result, an operation command instructing to select an operating mode, to start operating, or to stop operating from the data processing device 10, the machine 22 changes the operating state in accordance with the operation command.

The machine 23 is connected to a sensor 23a used in a product manufacturing process. The machine 23 obtains a sensing result from the sensor 23a and periodically transmits data including the sensing result to the data processing device 10 at intervals specified by the data processing device 10.

The machines 21, 22, and 23 connected to the data processing device 10 are hereafter collectively referred to as machines 20. A data transmission path 40 connecting the data processing device 10 to each machine 20 is not limited to a wired communication path, such as the network 41 or the network 43, and may be a transmission path for wireless communication.

Each machine 20 is not limited to either one of a machine that transmits data including a sensing result and a machine that operates in accordance with an operation command from the data processing device 10. The machine 20 may both transmit data to the data processing device 10 and operate in accordance with an operation command from the data processing device 10.

The data processing device 10 is a programmable logic controller (PLC) or an industrial personal computer. The data processing device 10 is a factory automation (FA) machine that performs a predefined process on data collected from the machines 20 and outputs a processing result. Although the data processing device 10 transmits, as an output of the processing result, an operation command to a machine 20, the present disclosure is not limited to such a configuration, and the data processing device 10 may present, to the user, quality control information obtained by analyzing or processing the data or may store the quality control information in the data processing device 10 or in an external server.

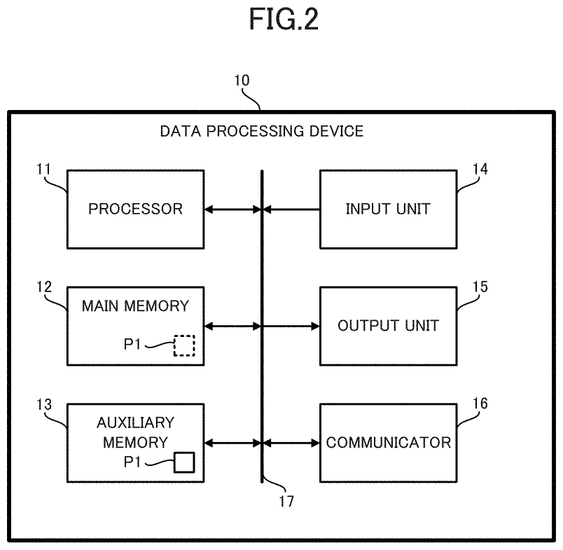

As shown in FIG. 2, the data processing device 10 is a computer with a hardware configuration including a processor 11, a main memory 12, an auxiliary memory 13, an input unit 14, an output unit 15, and a communicator 16. The main memory 12, the auxiliary memory 13, the input unit 14, the output unit 15, and the communicator 16 are all connected to the processor 11 via an internal bus 17.

The processor 11 includes a micro processing unit (MPU). The processor 11 executes a program P1 stored in the auxiliary memory 13 to implement the various functions of the data processing device 10 and perform the processing described later.

The main memory 12 includes a random access memory (RAM). The main memory 12 stores the program P1 loaded from the auxiliary memory 13. The main memory 12 is used as a work area for the processor 11.

The auxiliary memory 13 includes a non-volatile memory, typically an electrically erasable programmable read-only memory (EEPROM). The auxiliary memory 13 stores, in addition to the program P1, various data used in the processing performed by the processor 11. The auxiliary memory 13 supplies, to the processor 11, data used by the processor 11 in accordance with an instruction from the processor 11, and stores data supplied by the processor 11. Although FIG. 2 shows, as a typical example, the single program P1 that is stored in the auxiliary memory 13, multiple programs P1 may be stored. The programs P1 may include a program preinstalled in the data processing device 10 and a program added by the user of the data processing device 10.

The input unit 14 includes input devices, typically input keys and a pointing device. The input unit 14 obtains information input by the user of the data processing device 10, and provides the obtained information to the processor 11.

The output unit 15 includes output devices, typically a liquid crystal display (LCD) and a speaker. The output unit 15 presents various pieces of information to the user in accordance with an instruction from the processor 11.

The communicator 16 includes a network interface circuit for communicating with the external machines 20. The communicator 16 receives signals from the machines 20 and outputs data represented by the signals to the processor 11. The communicator 16 also transmits signals representing data output from the processor 11 to the machines 20.

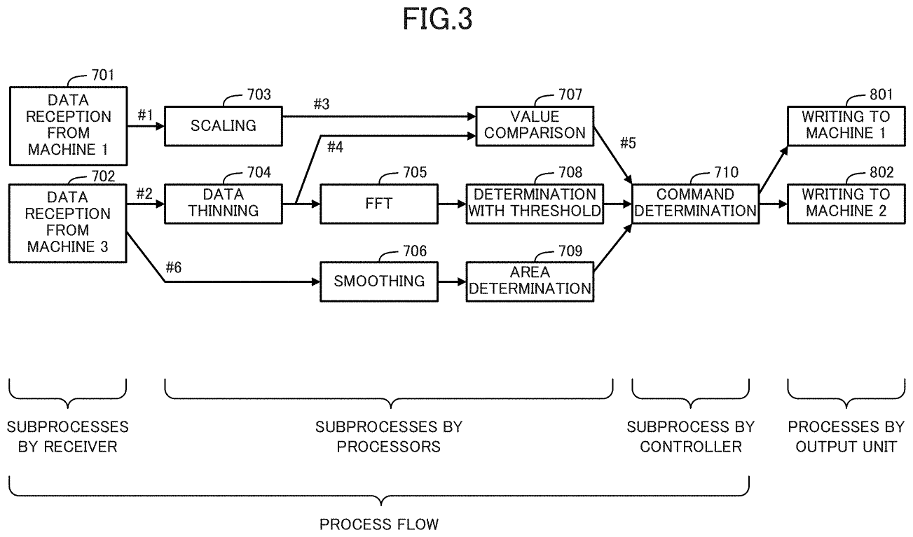

The data processing device 10 performs a process flow defined by the user by cooperation between the hardware components shown in FIG. 2. As illustrated in FIG. 3, the process flow defined for the data processing device 10 is accomplished by executing multiple subprocesses 701 to 710 in a preset order.

As indicated by the arrows in FIG. 3, an output value resulting from execution of each subprocess is input into a subsequent subprocess. For example, as indicated by the arrow drawn from the subprocess 701 to the subprocess 703, data resulting from the subprocess of receiving data from Machine 1 subsequently undergoes scaling. The arrows each represent at least either of input data to the subprocesses 701 to 710 or output data from the subprocesses 701 to 710. The input data and the output data have data labels. For example, the subprocess 703 receives input data labeled “#1” and outputs data labeled “#3”. The data labels are used to identify data input into and output from the subprocesses in the process flow. The data labels are not used to identify data itself. For example, any data repeatedly output from the subprocess 703 is labeled “#3”. The data labels may be set in a freely-selected manner by the user or may be assigned by the data processing device 10. Machine 1, Machine 2, and Machine 3 in FIG. 3 are label names as which the machines 21, 22, and 23 are labeled by the user.

In FIG. 3, the subprocess 701 of receiving data from Machine 1 and the subprocess 702 of receiving data from Machine 3 each means a subprocess of receiving data transmitted from the machine 20.

The subprocess 703 of scaling means a subprocess of multiplying the input value by a preset coefficient and then adding a preset offset value to the product resulting from the multiplication. Such scaling includes normalization. The subprocess 704 of data thinning means a subprocess of removing some of repeatedly-inputted input values and outputting the remaining input values as they are. Such data thinning includes, for example, removing input values at predetermined intervals. The subprocess 705 of FFT means a subprocess of performing fast Fourier transform (FFT) by which time series data is transformed into data in frequency representation. The subprocess 706 of smoothing means a subprocess of removing noise from a series of input values. Such smoothing includes, for example, outputting the mean of a predetermined number of input values. These subprocesses 703 to 706 correspond to data processing.

The subprocess 707 of value comparison means a subprocess of comparing the magnitude of two input values. The subprocess 708 of determination with a threshold means a subprocess of comparing an input value with a preset threshold. The subprocess 709 of area determination means a subprocess of determining whether all repeatedly-inputted input values are within a tolerance of a preset reference value. The area is a time range including times at which input values are sampled. These subprocesses 707 to 709 correspond to data analysis processing and diagnosis processing.

Although the subprocesses 703 to 706 for processing data and the subprocesses 707 to 709 for analyzing and diagnosing data are separate processes in the example in FIG. 3, the present disclosure is not limited to this example. For example, FFT and determination with the threshold may be merged into a single subprocess.

The process flow may include a branching portion at which an output value from one subprocess is input into two or more other subprocesses, like an output from each of the subprocesses 702, 704, and 710. The process flow may include a merged portion at which outputs from two or more subprocesses are input into a single subprocess, like an input to each of the subprocesses 707 and 710.

The subprocess 710 of command determination means a subprocess of determining an operation command to be provided to a machine 20 based on whether an input value satisfies a preset condition. A manner of determining the operation command is described in detail later. A process 801 of writing data to Machine 1 and a process 802 of writing data to Machine 2 each mean a process of providing an operation command by writing the command data to the storage area of the machine 20.

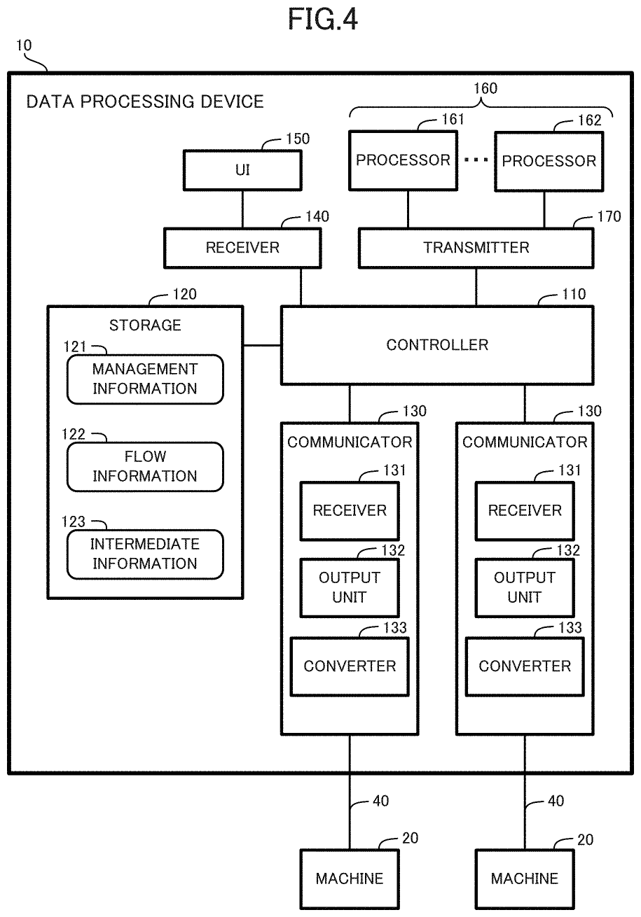

To perform the process flow shown as an example in FIG. 3, as shown in FIG. 4, the data processing device 10 includes, as the functional components, a controller 110 that controls the components of the data processing device 10, a storage 120 that stores various data a communicator 130 provided in accordance with the type of a transmission path 40 to communicate with each machine 20, a receiver 140 that receives a setting on a process flow defined for data received by the communicator 130, a user interface (UI) 150 that allows the user to define the process flow, multiple processors 161 and 162 that perform subprocesses included in the process flow, and a transmitter 170 that allows data transmission between the controller 110 and the processors 161 and 162. The processors 161 and 162 are hereafter collectively referred to as processors 160. Although FIG. 4 shows, as a typical example, the processors 161 and 162 that perform subprocesses, the data processing device 10 is to include seven processors 160 that perform the respective subprocesses 703 to 709 in a case in which the process flow shown as an example in FIG. 3 is performed. However, the present disclosure is not limited to such a configuration, and a single processor 160 may perform the multiple subprocesses shown in FIG. 3. The number of processors 160 may differ from the number of subprocesses.

The controller 110 controls the processors 160 to perform the defined process flow. In detail, the controller 110 obtains data received by the communicator 130. The controller 110 then transmits the obtained data to one of the processors 160 through the transmitter 170 and causes the processors 160 to perform the subprocesses in the order corresponding to the process flow. The controller 110 also performs the subprocess 710 included in the process flow shown in FIG. 3. The controller 110 obtains a processing result from the process flow obtained through execution of the multiple subprocesses, and transmits the processing result to an output unit 132 included in the communicator 130. The controller 110 is implemented mainly by the processor 11. In detail, the controller 110 is implemented by the processor 11 executing at least a part of the program P1. The controller 110 functions as control means in the claims.

The data stored in the storage 120 includes management information 121 used by the controller 110 to manage the processors 160, flow information 122 indicating the process flow the setting of which is received by the receiver 140, and intermediate information 123 temporarily generated while the process flow is being performed. The management information 121, the flow information 122, and the intermediate information 123 are described in detail later. The storage 120 is implemented mainly by the auxiliary memory 13. However, the present disclosure is not limited to such a configuration, and the storage 120 may be implemented by the main memory 12 or by both the main memory 12 and the auxiliary memory 13 cooperating with each other. The storage 120 functions as storage means in the claims.

The communicator 130 receives, in accordance with an instruction from the controller 110, data transmitted from the machine 20 through the transmission path 40, and transmits the received data to the controller 110. The communicator 130 is implemented mainly by the communicator 16. The communicator 130 functions as communication means in the claims. The communicator 130 includes a receiver 131 that receives data transmitted from the machine 20, the output unit 132 that outputs information indicating a processing result from the execution of the process flow, and a converter 133 that converts data transmitted on a communication protocol corresponding to the transmission path 40 into data on a common protocol suited to the controller 110.

The receiver 131 receives, in accordance with an instruction from the controller 110, data transmitted from the machine 20 through the transmission path 40, and transmits the received data to the controller 110. The receiver 131 converts the protocol using the converter 133 and transmits the data on the converted protocol to the controller 110. The data reception performed by the receiver 131 corresponds to the subprocesses 701 and 702 in FIG. 3.

The output unit 132 obtains, from the controller 110, an operation command to the machine 20 as a result of the process flow. The output unit 132 then transmits the operation command to the machine 20. In detail, the output unit 132 writes, in accordance with an instruction from the controller 110, information indicating the operation command to the machine 20 through the transmission path 40. In the same manner as the receiver 131, the output unit 132 converts the protocol using the converter 133 and outputs the data on the converted protocol. The output unit 132 is implemented mainly by the communicator 16. The output unit 132 functions as output means in the claims.

The receiver 140 receives the setting on the process flow defined by the user, and transmits, to the controller 110, flow information 122 indicating the content of the process flow. The controller 110 stores the sequence information 122 transmitted to the controller 110 into the storage 120. The receiver 140 is implemented mainly by the processor 11. The receiver 140 functions as reception means in the claims.

The UI 150 obtains an instruction from the controller 110 through the receiver 140, and presents, to the user in accordance with the instruction, a screen for inputting the content of the process flow. The UI 150 provides information about the content of the process flow defined by the user to the receiver 140. The UI 150 is implemented mainly by the processor 11, the input unit 14, and the output unit 15 cooperating with one another. The UI 150 is developed as an engineering tool for defining the process flow.

The processors 160 each perform a subprocess on data input from the controller 110 through the transmitter 170, and output a processing result obtained from the subprocess to the controller 110 through the transmitter 170. The processors 160 are implemented mainly by the processor 11 executing a part of the program P1. Since a component that the processors 160 transmit and receive data to and from is limited to the transmitter 170, software for implementing the processors 160 is developed as a highly independent software component or library. More specifically, the processors 160 do not transmit or receive data to or from any component shown in FIG. 4 other than the transmitter 170. The software component or library for implementing the processors 160 may be added as appropriate after the data processing device 10 is shipped or installed. The program for implementing the processors 160 may differ from the program for implementing the controller 110. The processors 160 may be implemented by the controller 110 successively activating programs for implementing the processors 160. The processors 160 function as processing means in the claims.

The transmitter 170 is an interface that allows data transmission between the controller 110 and the processors 160. The transmitter 170 is implemented mainly by the processor 11.

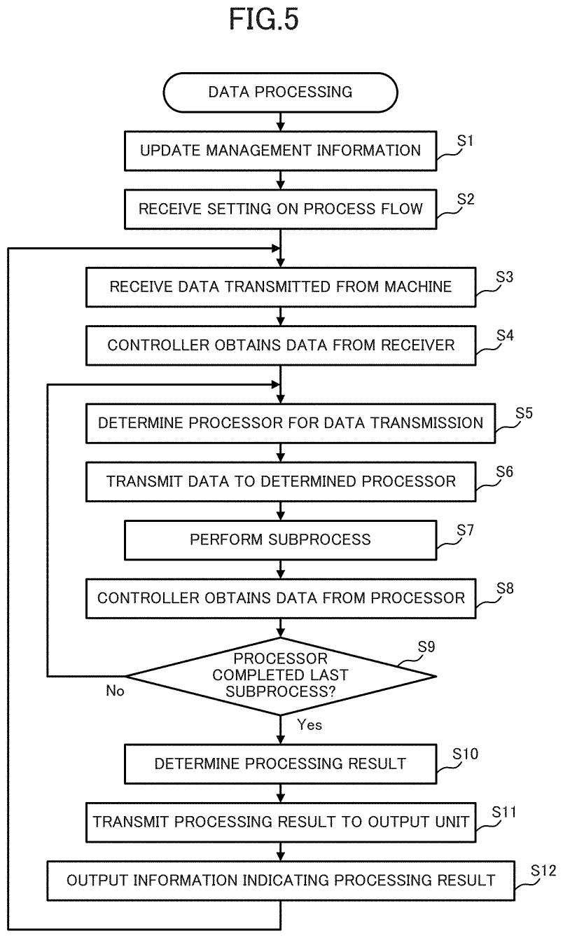

The data processing performed by the data processing device 10 is next described in detail with reference to FIGS. 5 to 13. The data processing shown in FIG. 5 starts upon turning on the data processing device 10 or in response to a user operation.

During the data processing, the data processing device 10 updates the management information 121 stored in the storage 120 (step S1). More specifically, the controller 110 determines subprocesses implementable by the controller 110 itself, the communicator 130, and the processors 160. For example, the controller 110 updates the management information 121 in a case in which a software component or library implementing the processors 160 is added by the user, in a case in which firmware is updated to comply with a new communication protocol, in a case in which a machine 20 is connected to the data processing device 10 through a transmission path 40, and in a case in which a program for implementing the communicator 130 is added or activated.

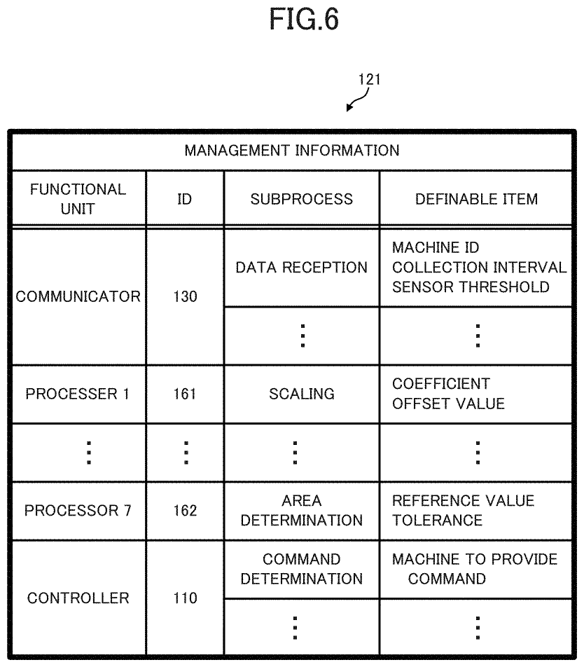

As illustrated in FIG. 6, the management information 121 is a table associating, with one another, a functional unit to perform a subprocess, an identification (ID) of the functional unit, a subprocess, and definable items as parameters used for performing the subprocess. In FIG. 6, the communicator 130, the processors 161 and 162, and the controller 110 as functional units to perform subprocesses have “ID” as a reference numeral. The definable items are added to the management information 121 by the controller 110 reading information about the definable items held by the communicator 130 and the processors 160.

Referring back to FIG. 5, subsequent to step S1, the data processing device 10 receives a setting on a process flow from the user (step S2). More specifically, the controller 110 reads management information 121 from the storage 120 and provides the management information 121 to the receiver 140. Based on the management information 121, the receiver 140 transmits screen data for generating an input screen to the UI 150. In this manner, the user can define the process flow by operating the UI 150.

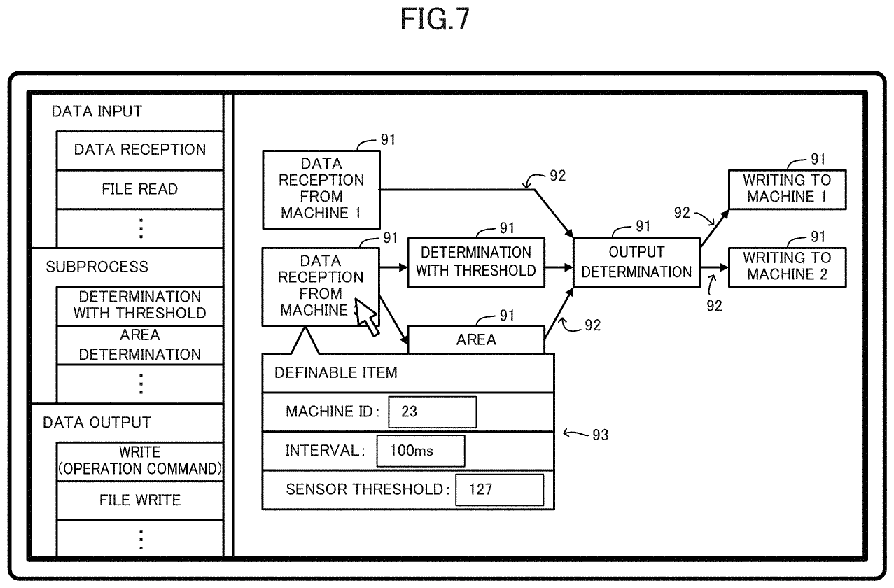

FIG. 7 is a diagram showing an example of the input screen for defining a process flow. In the example shown in FIG. 7, blocks 91 representing subprocesses and arrows 92 representing the direction of data transmission between the subprocesses are displayed in the same manner as in FIG. 3. The content of the process flow shown in FIG. 7 are simplified from the process flow shown in FIG. 3. The user drags blocks 91 representing subprocesses in the list appearing on the left, and places the blocks 91 into the right section. When the user selects one of the blocks 91, a menu 93 for inputting a definable item for the subprocess corresponding to the selected block 91 is displayed. The menu 93 shown in FIG. 7 includes, as definable items for performing the subprocess of receiving data from Machine 3, the ID of the machine from which data is to be received, the data collection interval, and a threshold to be set for the sensor. The user also sets the start point and the end point of each arrow 92. In such a manner, an order of execution of the subprocesses included in the process flow and the parameters for each subprocess are set.

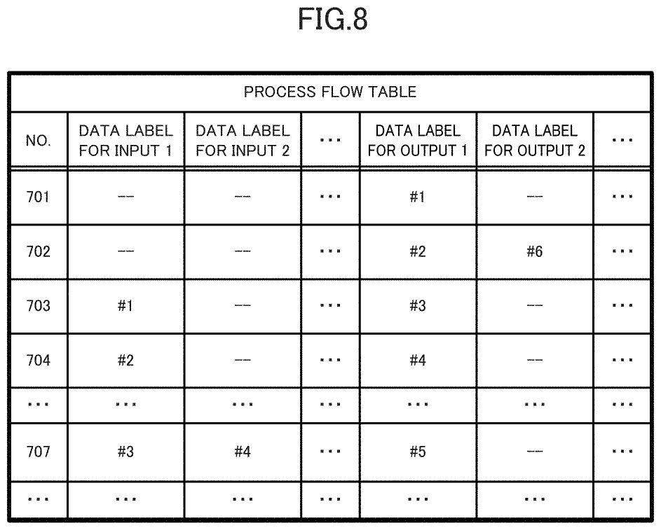

As shown in FIG. 8, the input screen for defining the process flow may be a screen displaying table-like entry fields. The process flow table shown in FIG. 8 associates, with one another, a number assigned to each subprocess, a data label assigned to input data for the subprocess, a data label assigned to output data from the subprocess, and definable items for the subprocess. The numbers in FIG. 8 are the same as the reference numerals of the respective subprocesses shown in FIG. 3. Rows of the process flow table in FIG. 8 correspond to the subprocesses 701 to 710 in FIG. 3, and the links between the subprocesses indicated by the data labels for input and output correspond to the arrows in FIG. 3.

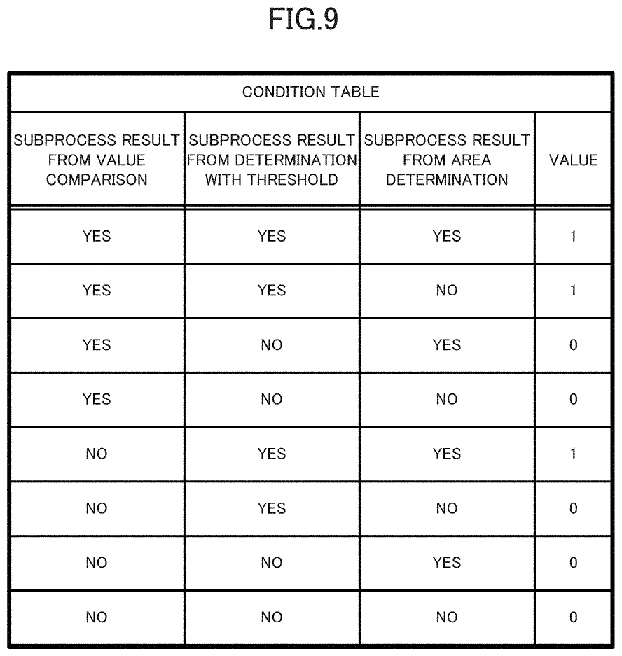

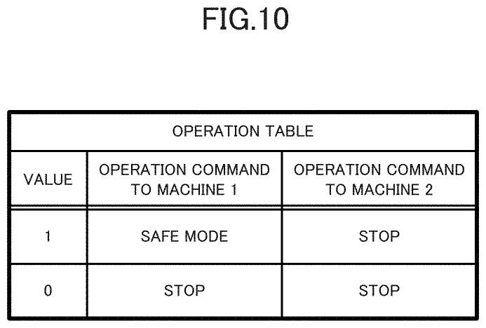

The definable items for command determination performed at the end of the process flow shown in FIGS. 7 and 8 is described. The definable items for command determination include conditions for the input values and the operations depending on whether the input values satisfy the conditions. FIG. 9 is an example of a condition table defining the conditions for the input values. FIG. 10 is an example of an operation table defining the operations.

The condition table in FIG. 9 defines values depending on the results obtained from the subprocesses of value comparison, determination with the threshold, and area determination. For example, the value is 1 when the result from value comparison is YES, the result from determination with the threshold is YES, and the result from area determination is YES. The operation table in FIG. 10 defines operation commands for the machines corresponding to the values. For example, when the value of 1 is obtained from the condition determination, a command is transmitted to Machine 1 to change the operation state to a safe mode and a command is transmitted to Machine 2 to stop operating.

Referring back to FIG. 5, in step S2, the receiver 140 provides, to the controller 110, the flow information 122 indicating the content of the process flow defined by the user. Next, the data processing device 10 receives data transmitted from a machine 20 (step S3). More specifically, the communicator 130 performs the subprocess of receiving data defined by the flow information 122. For example, the communicator 130 receives data transmitted from the machine 21 or 23 shown in FIG. 1. In more detail, the communicator 130 receives data by instructing the machine 20 to transmit data in accordance with the content of a definable item for the data reception.

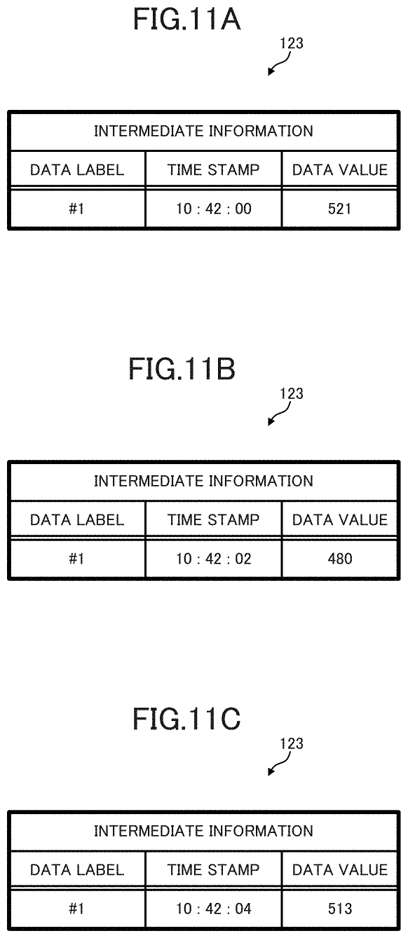

The communicator 130 then transmits the received data to the controller 110, and the controller 110 obtains the data from the communicator 130 (step S4). The controller 110 stores, as intermediate information 123, the obtained data into the storage 120. FIG. 11A shows an example of intermediate information 123 resulting from step S4. The intermediate information 123 is information that is associated with a data label assigned to data, a time stamp indicating the time at which the data to undergo the process flow is received by the communicator 130, and the data value. The intermediate information 123 shown in FIG. 11A indicates that data labeled “#1” is obtained as a result of performing the subprocess 701 shown in FIG. 3 on data received by the communicator 130 at 10:42:00 and the data labeled “#1” has a data value of 521. This indicates that a subsequent process that is performed on the data received from the machine 21 is the subprocess 704.

Referring back to FIG. 5, subsequent to step S4, the controller 110 determines a processor to which the data is to be transmitted (step S5). More specifically, the controller 110 determines a processor 160 to which the data included in the intermediate information 123 is to be transmitted by referring to the flow information 122 stored in the storage 120.

Next, the controller 110 transmits the data to the determined processor 160 (step S6). More specifically, the controller 110 inputs the data value included in the intermediate information 123 into the processor 160 determined in step S5.

The processor 160 that has obtained the data from the controller 110 then performs the subprocess (step S7). The processor 160 transmits, to the controller 110, data representing the result obtained from the subprocess. The result obtained from the subprocess performed by each processor 160 is hereafter referred to as a subprocess result.

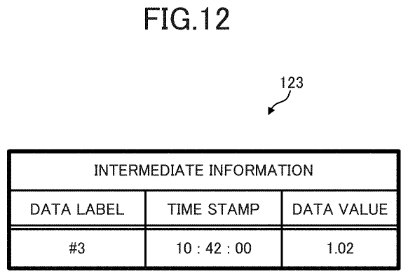

Next, the controller 110 obtains data indicating the subprocess result from the processor 160 (step S8). The controller 110 stores, as intermediate information, the obtained data into the storage 120. FIG. 12 shows an example of intermediate information 123 obtained from the execution of step S8. The intermediate information 123 shown in FIG. 12 indicates that data labeled “#3” is obtained as a result of performing the subprocesses 701 and 703 shown in FIG. 3 on the data received by the communicator 130 at 10:42:00 and the data labeled “#3” has a data value of 1.02.

Referring back to FIG. 5, subsequent to step S8, the controller 110 determines whether the subprocess performed by the last processor 160 in the process flow is complete (step S9). More specifically, the controller 110 determines, by referring to the flow information 122, whether the intermediate information 123 stored in the storage 120 is information indicating a result of the last subprocess performed by the processor 160 among the subprocesses included in the process flow.

When the controller 110 determines that the last subprocess to be performed by the processor 160 is not complete (No in step S9), the processing in step S5 and processing in subsequent steps are performed repeatedly. For example, referring to the intermediate information 123 shown in FIG. 12 and the flow information 122, it can be understood that the subsequent processing is the subprocess 704. Thus, when the storage 120 stores the intermediate information 123 in FIG. 12, the processor to which the data included in the intermediate information 123 is to be transmitted is determined by referring to the flow information 122 in step S5. By repeatedly performing transmission and reception of data between the processors 160 and the controller 110 in the above manner, the subprocesses included in the process flow is sequentially performed.

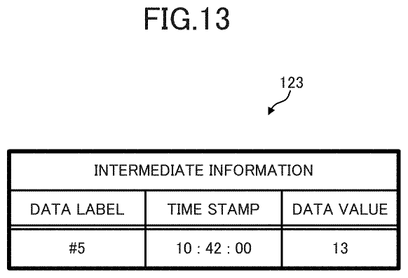

Referring back to FIG. 5, when determining, in step S9, that the last subprocess to be performed by the processor 160 is complete (Yes in step S9), the controller 110 finds a processing result that is a result of the execution of the process flow (step S10). For example, the intermediate information 123 shown in FIG. 13 indicates that data labeled “#5” is obtained as a result of performing the subprocesses 701 to 704 and 707 shown in FIG. 3 on the data received by the communicator 130 at 10:42:00 and the data labeled “#5” has a data value of 13. By referring to the flow information 122, it can be understood that the last subprocess performed by the corresponding processor 160 in the process flow is complete. The controller 110 then performs the subprocess 710 of command determination to determine the content of the operation command.

Referring back to FIG. 5, subsequent to step S10, the controller 110 transmits the processing result to the output unit 132 (step S11). More specifically, the controller 110 instructs the output unit 132 to transmit, to the machine 20, the operation command for the machine 20.

Next, the output unit 132 outputs information indicating the processing result of the process flow (step S12). More specifically, the output unit 132 transmits, to the machine 20, a signal for writing the operation command to the machine 20. Subsequently, the processing in step S3 and processing in subsequent steps are performed repeatedly. In the above manner, the data processing device 10 can output the result of performing the process flow on the data repeatedly transmitted from the machine 20.

FIGS. 11B and 11C each show an example of the intermediate information 123 generated in step S4 that is performed repeatedly. The intermediate information 123 shown in FIG. 11B indicates that data labeled “#1” is obtained as a result of performing the subprocess 701 shown in FIG. 3 on the data received by the communicator 130 at 10:42:02 and the data labeled “#1” has a data value of 480. The intermediate information 123 shown in FIG. 11C indicates that data labeled “#1” is obtained as a result of performing the subprocess 701 shown in FIG. 3 on the data received by the communicator 130 at 10:42:04 and the data labeled “#1” has a data value of 513.

As described above, the data processing device 10 includes multiple processors 160 that perform subprocesses, and the controller 110 causes the processors 160 to perform the subprocesses in the order corresponding to the process flow and transmits the processing results obtained through the execution of the subprocesses. Accordingly, by changing an order in which the subprocesses are performed, various process flows can be performed. Thus, a process flow obtained by combining various processing steps can be easily performed on data.

Each of the multiple processors 160 transmits, to the controller 110, a subprocess result obtained by performing a subprocess on data transmitted from the controller 110. The controller 110 causes the multiple processors 160 to perform the subprocesses by transmitting, to a subsequent processor 160, data indicating a subprocess result transmitted from one processor 160 in accordance with the process flow indicated by the flow information 122. Thus, an component that the processors 160 transmit and receive data to and from is limited to the controller 110. Thus, such a configuration allows easy development of the program P1 for implementing the processors 160 and also allows the user to easily add an intended subprocess, thereby making it easy to perform a freely-selected process flow on data.

Each machine 20 repeatedly transmits data. The storage 120 stores, as intermediate information 123, a subprocess result obtained by performing a subprocess on data received by the communicator 130 such that the subprocess result is associated with a data label for identifying the data input into and output from the subprocess. The controller 110 determines, by referring to the data label of the intermediate information 123 and the flow information 122 indicating the process flow, a subsequent processor 160 to which the data indicating the subprocess result is to be transmitted. The controller 110 can thus transmit data to an appropriate processor by merely referring to the storage 120 without simultaneously managing the multiple processors 160. Accordingly, such a configuration reduces the load on the controller 110, thereby also reducing the load on the processor 11. Thus, the processors 160 can afford to perform subprocesses that impose relatively high loads, thereby enabling various process flows.

The data transmitted from each machine 20 includes a sensing result from the sensor. The output unit 132 outputs an operation command to at least either the machine 20 that has transmitted the data or another machine 20. The data processing device 10 is thus suitable for a system installed at a facility, typically at a factory.

In the example shown in FIG. 5, for ease of understanding, data is first received by the communicator 130, data is transmitted to and received from the controller 110 and the processors 160, and then information is output from the output unit 132, in the stated order. In this example, new data is received from a machine 20 after the process flow is complete. However, a data process by the data processing device 10 is not limited to such a manner, and the data processing device 10 may receive new data from a machine 20 as appropriate during execution of the process flow. The controller 110, the communicator 130, and the output unit 132 may function in parallel.

More specifically, the communicator 130 may receive data as appropriate and transmit the data to the controller 110, and the controller 110 may transmit and receive data, as appropriate, to and from each processor 160. The controller 110 refers to the intermediate information 123 resulting from completion of one subprocess, and transmits data, as appropriate, to the processor 160 to perform the subsequent subprocess. Each processor 160 performs the subprocess at a time that is preset for each processor 160. The controller 110 may transmit data at predetermined timing to cause each processor 160 to perform the subprocess.

### Embodiment 2

Embodiment 2 is described focusing on the differences from Embodiment 1 described above. The same or corresponding components as in Embodiment 1 are given the same reference numerals, and is not described or is described briefly. In Embodiment 1 described above, if each processor 160 properly fulfills its function, no restriction is put on the process flow. Thus, the software implementing the processors 160 may be developed by the owner or manager of the facility at which the data processing device 10 is installed or may be open source software.

However, generally, paid plug-in software distributed by professional software developers often has higher quality and more functions than such software. Accordingly, a restriction is placed on the use of the plug-in software for implementing the processors 160, and, when a user pays a price for the plug-in software, the restriction on the use of the plug-in software is removed for the user. Such a manner can encourage the development of paid software, and it can be expected that the user easily performs more various process flows at relatively low cost.

Additionally, even if the plug-in software itself is a free software, it can be considered that software developers may specify machines 20 that can use the plug-in software and place a restriction on execution of data processing related to the high-quality machines 20. Independently of the plug-in software, a restriction may be placed on the process flow that uses high-quality machines 20 manufactured by a professional manufacturer. As a result, it can be expected that the user easily performs more various process flows at relatively low cost.

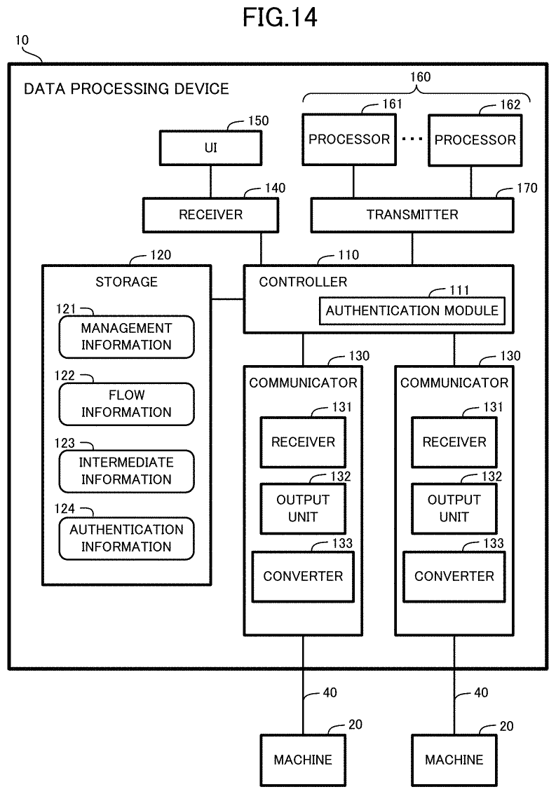

An embodiment in which restrictions are placed on the process flow is described below. As shown in FIG. 14, a data processing device 10 according to the present embodiment differs from the data processing device 10 according to Embodiment 1 in that the controller 110 includes an authentication module 111 and the storage 120 stores authentication information 124 in the present embodiment.

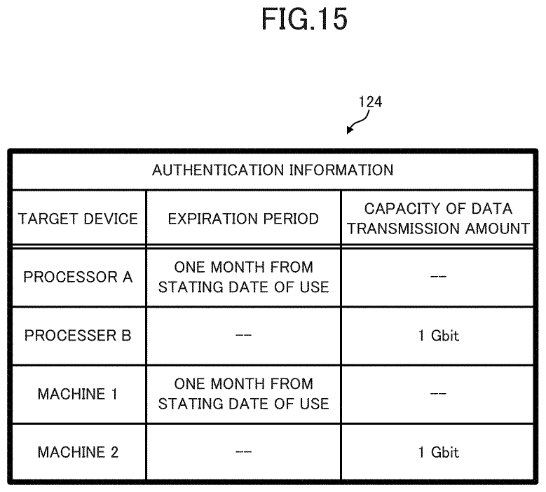

As shown as an example in FIG. 15, authentication information 124 is a table associating, with one another, (i) a target device to be used for executing the process flow, (ii) an expiration period that is a period during which the target device is usable, and (iii) the capacity of data transmission through the device. The first row of the authentication information 124 indicates that an expiration period of the use of a processor A is limited to one month from a starting date of use of the processor A. The second row of the authentication information 124 indicates that a data transmission amount through a processor B is limited to 1 Gbit. The third row of the authentication information 124 indicates that an expiration period of the use of Machine 1 is limited to one month from a starting date of use of the Machine 1. The fourth row of the authentication information 124 indicates that a data transmission amount through Machine 2 is limited to 1 Gbit.

The data transmission amount through a processor 160 means a cumulative amount of data transmitted through the transmitter 170. Also, the data transmission amount through a machine 20 means a cumulative amount of data transmitted between the machine 20 and the data processing device 10.

The controller 110 inquires of a non-illustrated external server about payment status and updates the authentication information 124 when a fee has been paid. The user can thus use the processor 160 or the machine 20 by paying the fee.

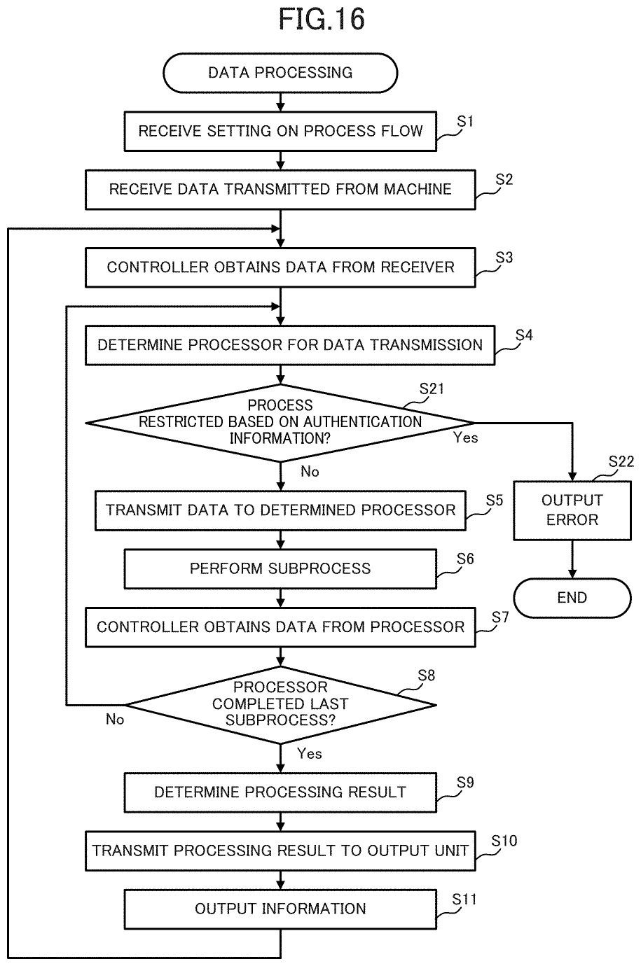

Subsequently, the data processing performed by the data processing device 10 is described with reference to FIG. 16. In the data processing shown in FIG. 16, steps S1 to S4 that are the same as the corresponding steps in FIG. 5 are performed.

Subsequent to step S4, the controller 110 determines whether to restrict execution of the process flow based on the authentication information 124 (step S21). More specifically, the controller 110 determines whether restrictions are placed on the use of the processor 160 determined in step S4, on the use of a machine 20 that has transmitted the data from which the intermediate information 123 is derived, and on the use of a machine 20 to which an operation command obtained from the intermediate information 123 as a result of further performing a subprocess is to be transmitted. The controller 110 determines that execution of the process flow should be restricted when a restriction is placed on the use of at least one of the target devices.

When the controller 110 determines, in step S21, that the execution of the process flow should not be restricted (No in step S21), the processing in step S5 and processing in subsequent steps are performed. When the controller 110 determines that the process flow should be restricted (Yes in step S21), the data processing device 10 outputs an error (step S22) and ends the data processing. The output of the error may be a warning displayed on the screen of the UI 150, an alert sound from a speaker, or transmission of error information from the output unit 132 to a user terminal.

As described above, at least one of the multiple processors 160 is implemented with plug-in software. As a result, easier development of plug-in software is possible, and the user can easily add intended subprocesses, as in Embodiment 1, thereby making it possible to easily performing a freely-selected process flow on data.

The controller 110 restricts the execution of the process flow in accordance with the data transmission amount through the processor 160 implemented by plug-in software. Accordingly, the processor 160 is implemented with plug-in software provided by a professional software developer, and thus it can be expected that the user of the data processing device 10 easily perform more various process flows at relatively low cost.

Also, the controller 110 restricts the execution of the process flow in accordance with the data transmission amount between the data processing device 10 and a machine 20. Accordingly, it can be expected that the user of the data processing device 10 uses the machine 20 manufactured by a professional manufacturer to perform various process flows easily at relatively low cost.

The controller 110 restricts the execution of the process flow in accordance with the amount of time elapsed from a predetermined time. More specifically, the controller 110 restricts the execution of the process flow employing the processor 160 or the machine 20 specified by the authentication information 124 in accordance with the time elapsed from a starting date of the use of the processor 160 or the machine 20 to the present time. Thus, it can be expected that the user of the data processing device 10 easily performs more various process flows at relatively low cost.

Although the embodiments of the present disclosure are described above, the present disclosure is not limited to the above embodiments.

For example, in Embodiments 1 and 2 described above, the data processing system 1000 is installed at a facility, typically at a factory, as a production manufacturing system. However, the present disclosure is not limited to such an example. The data processing system 1000 may be a product production system, a manufacturing system, a processing system, an inspection system, an industrial control system, or another system. Also, the data processing system 1000 may be installed at a plant such as a power plant, at a movable object such as an automobile, an airplane, or a ship, or at an office building, or a public facility, typically a school.

In the above embodiments, the system includes three machines 20. However, the present disclosure is not limited to such an example, and the system may include less than or more than three machines 20. The transmission path 40 is a bidirectional transmission path in the above-described embodiments. The transmission path 40 may be a communication path that only transmits information in one direction.

Also, the data transmitted from a machine 20 is not limited to data including a sensing result and may be, for example, data indicating an operating state of the machine 20 or data including a result of signal processing performed by the machine 20. Additionally, the information transmitted to a machine 20 from the data processing device 10 as a result of data processing is not limited to the operation command and may be a notification indicating the operating state of the data processing device 10.

The receiver 131 and the output unit 132 are integrated to form one component as a communicator 130. However, the receiver 131 and the output unit 132 may be configured to be components separate from each other. Also, although the communicator 130 is provided for each type of the transmission path 40, the present disclosure is not limited to such an example. A single communicator 130 corresponding to multiple types of transmission paths 40 may be provided or multiple communicators 130 corresponding to transmission paths 40 of the same type may be provided.

Although the processors 160 transmit subprocess results to the controller 110, the present disclosure is not limited to such an example, and the processors 160 may directly store the subprocess results into the storage 120 in accordance with an instruction from the controller 110. As a result, the multiple processors 160 transmit and receive data via the storage 120 without using the controller 110.

Also, in Embodiments 1 and 2 described above, the controller 110 generates intermediate information 123 for controlling subprocesses performed by the processors 160. However, the present disclosure is not limited to such an example. The controller 110 may perform the process flow by referring to the flow information 122, without generating the intermediate information 123.

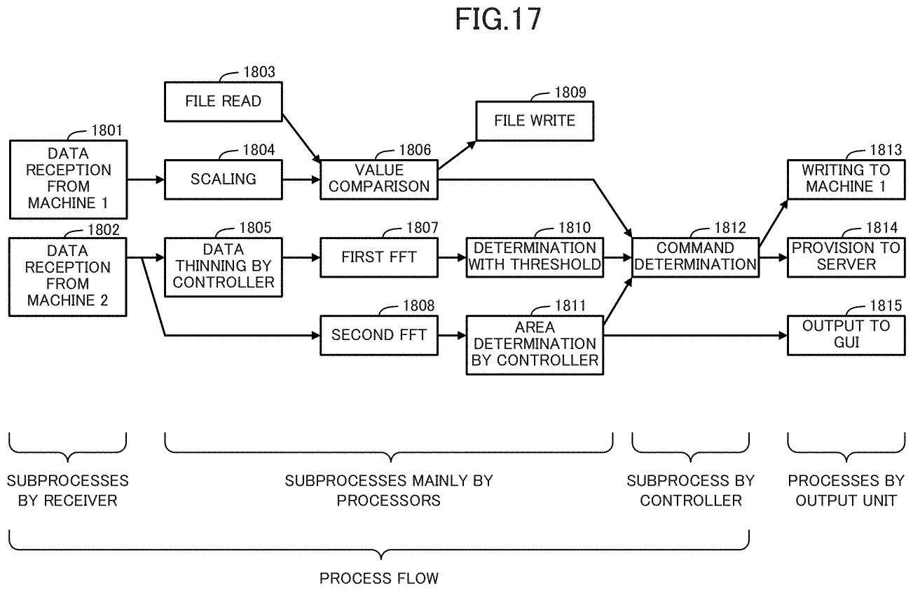

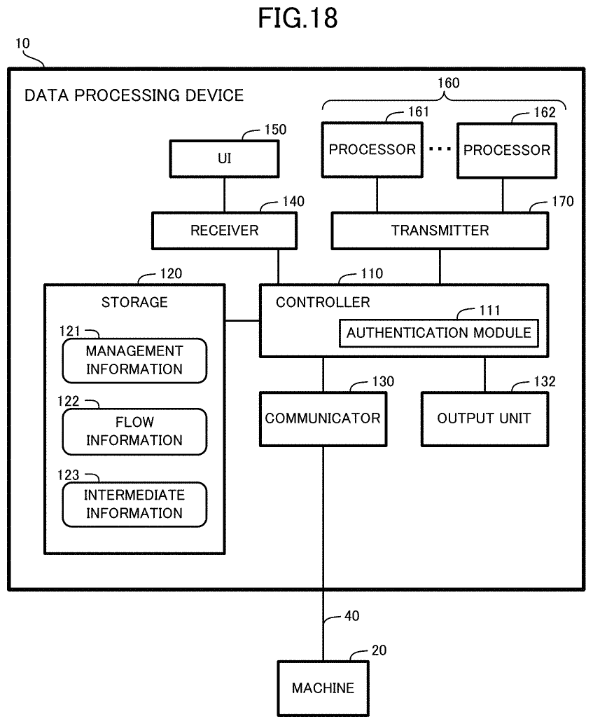

FIG. 17 shows a modified example of the process flow. As shown in FIG. 17, a subprocess 1805 may be performed by the controller 110, subsequent to a subprocess 1802 performed by the communicator 130. Also, a subprocess 1811 performed by a processor 160 may be added to the process flow. Also, the process flow may include two subprocesses 1807 and 1808 performed by the same processor 160. Additionally, a processor 160 may perform a subprocess 1803 of reading a file and a subprocess 1809 of writing a file. Also, the processing performed by the output unit 132 is not limited to the process of writing data to machines 20 and may be a process 1814 of providing information to a server or a process 1815 of outputting information by a graphical user interface (GUI). In this case, as shown in FIG. 18, the output unit 132 performing the process 1815 is separate from the communicator 130 and is implemented by the input unit 14 and the output unit 15.

The data processing device 10 may be configured without including the UI 150, and, the receiver 140 may obtain the flow information 122 from an external terminal.

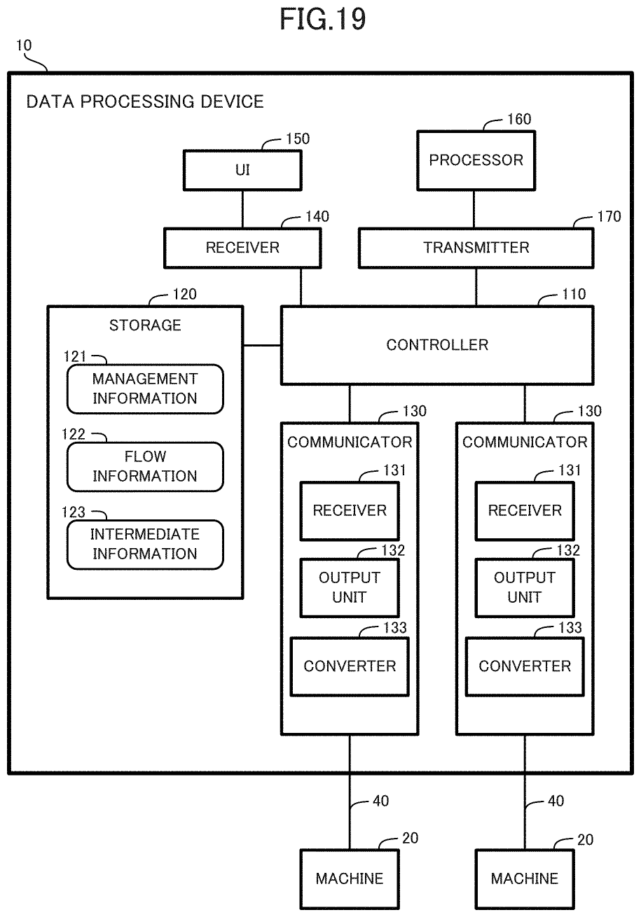

In Embodiments 1 and 2, the data processing device 10 includes multiple processors 160. However, the present disclosure is not limited to such an example. For example, as shown in FIG. 19, the data processing device 10 may include a single processor 160. In this case, the process flow may be an iterative process in which the processor 160 repeatedly performs implementable processing. Also, if a single processor 160 can process, analyze, and diagnose data in accordance with the content of definable items, the single processor 160 can perform the same process flow as shown in FIG. 3 by appropriately setting the definable items.

Also, the functions of the data processing device 10 can be implementable by dedicated hardware or a common computer system.

For example, the program P1 executed by the processor 11 may be stored in a non-transitory computer-readable recording medium, the recording medium is distributed, and the program P1 is installed in a computer, thereby making it possible to configure a device that performs the above-described processing. Examples of such recording mediums include a flexible disk, a compact disc read-only memory (CD-ROM), a digital versatile disc (DVD), and a magneto-optical (MO) disk.

Also, the program P1 may be stored in a disk unit included in a server on a communication network, typically the Internet, and may be, for example, superimposed on a carrier wave to be downloaded to a computer.

Also, the processing described above can be also performed by activating and executing the program P1 while the program P1 is being transferred through a communication network.

Additionally, the processing described above can be also performed by (i) executing the whole of or a part of the program P1 on a server and (ii) executing the program with a computer transmitting and receiving information about the processing through a communication network.

When the above-described functions are realized (i) by sharing tasks with an operating system (OS) or (ii) by cooperation between the OS and an application, only portions of the program P1 other than a portion of the program P1 executed by the OS may be stored in the medium and the medium may be distributed. Alternatively, such portions of the program P1 may be downloaded to a computer.

Also, means for implementing the functions of the data processing device 10 is not limited to software, and the whole of or a part of the functions may be implemented by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for processing collected data.

### REFERENCE SIGNS LIST

1000 Data processing system
10 Data processing device
11 Processor
12 Main memory
13 Auxiliary memory
14 Input unit
15 Output unit
16 Communicator
17 Internal bus
110 Controller
111 Authentication module
120 Storage
121 Management information
122 Flow information
123 Intermediate information
124 Authentication information
130 Communicator
131 Receiver
132 Output unit
133 Converter
140 Receiver
150 UI
160 to 162 Processor
170 Transmitter
20 to 23 Machine
21a, 23a Sensor
40 Transmission path
41 Network
43 Network
701 to 710, 1801 to 1811 Subprocess
801, 802, 1814, 1815 Process
91 Block
92 Arrow
93 Menu
P1 Program

1. A data processing device connectable to machines, the device comprising:
a communicator to communicate with the machines;
a receiver to receive a setting on a process flow for processing data received by the communicator; and
a controller to (i) transmit the data received by the communicator to one processor or one of processors to perform subprocesses included in the process flow and transmit a subprocessing result obtained by performing the subprocesses on the data, (ii) cause the one processor or the processors to execute the subprocesses in an order corresponding to the process flow by transmitting to a subsequent processor, based on the process flow, data indicating the subprocessing result transmitted from the one processor or one of the processors, and (iii) transmit a processing result obtained from execution of the subprocesses,
wherein
data transmitted from the controller to the one processor or the processors and data transmitted from the one processor or the processors to the controller are associated with a time stamp indicating a time at which the data is received by the communicator,
data repeatedly transmitted from the machines at respective specified periods and received by the communicator is identified by (i) machine IDs for identifying the machines that are senders of the data and (ii) the time stamp,
the subprocesses are performed at a timing that is set for the one processor or the processors that perform the subprocesses, and
the subprocesses are performed in parallel in response to the data transmitted from the respective machines.

2. (canceled)

3. The data processing device according to claim 1, further comprising:
a storage to store the subprocess result obtained by performing the subprocess on data that is repeatedly transmitted from the machines and is received by the communicator, the subprocess result being associated with a label for identifying data input into and output from the subprocess,
wherein the controller refers to the label associated with the subprocess result and the process flow and determines the subsequent processor to which the data indicating the subprocess result is to be transmitted.

4. The data processing device according to claim 1, wherein
the one processor or at least one of the processors is implemented by plug-in software.

5. The data processing device according to claim 4, wherein
the controller restricts execution of the process flow in accordance with an amount of data transmission through the processor implemented by plug-in software.

6. The data processing device according to claim 1, wherein
the controller restricts execution of the process flow in accordance with an amount of data transmission between the data processing device and the machine.

7. The data processing device according to claim 1, wherein
the controller restricts execution of the process flow in accordance with an amount of time elapsed from a predetermined time.

8. The data processing device according to claim 1, wherein
the data transmitted from the machine includes a sensing result from a sensor.

9. The data processing device according to claim 1, wherein
the communicator includes an output unit to output information indicating the processing result transmitted from the controller, and
the output unit outputs, as the information indicating the processing result, an operation command to at least one of the machine or another machine different from the machine.

10. A data processing method, comprising:
receiving data from machines by a communicator;
receiving, by a receiver, a setting on a process flow for processing the data received by the communicator;
transmitting, by a controller, the data received by the communicator to one processor or one of a plurality of processors to perform subprocesses included in the process flow and transmit a subprocessing result obtained by performing the subprocesses on the data;
causing, by the controller, the one processor or the processors to perform the subprocesses in an order corresponding to the process flow by transmitting to a subsequent processor, based on the process flow, data indicating the subprocessing result transmitted from the one processor or one of the processors; and
transmitting, by the controller, a processing result obtained from execution of the subprocesses,
wherein
data transmitted from the controller to the one processor or the processors and data transmitted from the one processor or the processors to the controller are associated with a time stamp indicating a time at which the data is received by the communicator,
data repeatedly transmitted from the machines at respective specified periods and received by the communicator is identified by (i) machine IDs for identifying the machines that are senders of the data and (ii) the time stamp,
the subprocesses are performed at a timing that is set for the one processor or the processors that perform the subprocesses, and
the subprocesses are performed in parallel in response to the data transmitted from the respective machines.

11. A non-transitory computer-readable recording medium for recording a program causing a computer to function as:
a communicator to receive data from machines;
a receiver to receive a setting on a process flow for processing the data received by the communicator; and
a controller to (i) transmit the data received by the communicator to one processor or one of processors to perform subprocesses included in the process flow and transmit a subprocessing result obtained by performing the subprocesses on the data, (ii) cause the one processor or the processors to execute the subprocesses in an order corresponding to the process flow by transmitting to a subsequent processor, based on the process flow, data indicating the subprocessing result transmitted from the one processor or one of the processors, and (iii) transmit a processing result obtained from execution of the subprocesses,
wherein
data transmitted from the controller to the one processor or the processors and data transmitted from the one processor or the processors to the controller are associated with a time stamp indicating a time at which the data is received by the communicator, data repeatedly transmitted from the machines at respective specified periods and received by the communicator is identified by (i) machine IDs for identifying the machines that are senders of the data and (ii) the time stamp,
the subprocesses are performed at a timing that is set for the one processor or the processors that perform the subprocesses, and
the subprocesses are performed in parallel in response to the data transmitted from the respective machines.

12. The data processing device according to claim 1, wherein
during execution of the process flow, the controller transmits, to the one processor or one of the processors, new data received by the communicator.
